(19) United States
(12) Patent Application Publication
(10) Pub. No.: US 2021/0272100 A1
(43) Pub. Date: Sep. 2, 2021

(54) SYSTEMS AND METHODS FOR PROCESSING PAYMENT CARD TRANSACTIONS BY USING A SINGLE PROXY CARD

(71) Applicant: STATE FARM MUTUAL AUTOMOBILE INSURANCE COMPANY, Bloomington, IL (US)

(72) Inventor: James A. Crough, Phoenix, AZ (US)

(21) Appl. No.: 14/686,214

(22) Filed: Apr. 14, 2015

Related U.S. Application Data
(60) Provisional application No. 62/103,724, filed on Jan. 15, 2015.

(51) Int. Cl. G06Q 20/34

(52) U.S. Cl. CPC G06Q 20/3572

(57) ABSTRACT

To overcome the inconvenience of carrying and using multiple different payment cards, a single proxy card is used to process various payment card transactions. Before starting a transaction, a user may select (1) a type of payment card and/or (2) a corresponding payment method to use for the single proxy card. During the transaction, charges incurred on the single proxy card may be recorded in a proxy account that is linked to the single proxy card. After which, the corresponding payment method associated with the selected payment card may be applied to clear or reimburse the charges in the proxy account. The proxy card and/or proxy account may relate to financial or bank accounts, credit or debit cards, and/or accounts with various types of merchants, including insurance providers or online retailers. A user interface may allow a user to manage the proxy card, and payment cards and corresponding payment methods.

### CROSS-REFERENCE TO RELATED APPLICATION

This application claims benefit of the filing date of U.S. Provisional Patent Application 62/103,724, filed on Jan. 15, 2015, and entitled “SYSTEMS AND METHODS FOR PROCESSING PAYMENT CARD TRANSACTIONS BY USING A SINGLE PROXY CARD,” the entire disclosure of which is hereby incorporated by reference herein.

### FIELD OF THE DISCLOSURE

The present disclosure generally relates to payment card transactions, and more particularly, to systems and methods for processing payment card transactions by using a single proxy card.

### BACKGROUND

A payment card is a type of card that may be used by an individual to make a payment for a transaction (e.g., a purchase). Typically, the payment card is electronically linked to an account belonging to the individual. However, the individual may own multiple different accounts, and thus may possess multiple different payment cards (e.g., a card for personal credit, a card for personal checking, a card for business expenses, etc.).

Accordingly, it may become inconvenient for the individual to carry and sort out the use of all the different payment cards. Efforts have been made to consolidate various payment cards into a single card. For example, a card with a rewritable magnetic stripe has been proposed that allows the card to dynamically switch card numbers. However, this approach requires additional equipment, which may be expensive, complicated to use, and prone to failure.

### SUMMARY

To overcome the inconvenience of carrying and using multiple different payment cards, a single proxy card may be used to process various payment card transactions. Before starting a transaction, a user may select a type of payment card and a corresponding payment method to use for the single proxy card. During the transaction, charges incurred on the single proxy card may be recorded in a proxy account, which may be linked to the single proxy card. After which, the corresponding payment method associated with the selected payment card may be applied to clear or reimburse the charges in the proxy account. The proxy card and/or proxy account may relate to financial or bank accounts; credit or debit card accounts; accounts associated with various types of merchants, including insurance providers or online retailers; and/or other types of personal accounts.

In one aspect, a computer-implemented method for processing payment card transactions may be provided. The method may include receiving, by one or more processors executing a processor-implemented instruction module, an indication of a selected payment card and a corresponding payment method from a user for use in subsequent transactions on a proxy card. The method may also include receiving, by the processor-implemented instruction module, an indication of a transaction conducted by the user using the proxy card. The method may further include recording, by the processor-implemented instruction module, a total amount of charges for the transaction in a proxy account linked to the proxy card. Further, the method may include sending, by the processor-implemented instruction module, a notification to inform the user of the transaction. Additionally, the method may include applying, by the processor-implemented instruction module, the corresponding payment method to clear the total amount of charges for the transaction in the proxy account. The method may include additional, fewer, or alternate actions, including those discussed elsewhere herein.

In another aspect, a non-transitory computer-readable storage medium including computer-readable instructions to be executed on one or more processors of a system for processing payment card transactions may be provided. The instructions when executed may cause the one or more processors to receive, by a processor-implemented instruction module, an indication of a selected payment card and a corresponding payment method from a user for use in subsequent transactions on a proxy card. The instructions when executed may also cause the one or more processors to receive, by the processor-implemented instruction module, an indication of a transaction conducted by the user using the proxy card. The instructions when executed may further cause the one or more processors to record, by the processor-implemented instruction module, a total amount of charges for the transaction in a proxy account linked to the proxy card. Further, the instructions when executed may cause the one or more processors to send, by the processor-implemented instruction module, a notification to inform the user of the transaction. Additionally, the instructions when executed may cause the one or more processors to apply, by the processor-implemented instruction module, the corresponding payment method to clear the total amount of charges for the transaction in the proxy account. The non-transitory computer-readable storage memory may include additional, fewer, or alternate computer-readable instructions, including those discussed elsewhere herein.

In another aspect, a computer system for processing payment card transactions may be provided. The system may include a proxy account repository and a proxy card server including a memory having instructions for execution on one or more processors. The instructions, when executed by the one or more processors, may cause the proxy card server to receive, via a network connection, an indication of a selected payment card and a corresponding payment method from a user for use in subsequent transactions on a proxy card. The instructions, when executed by the one or more processors, may also cause the proxy card server to receive, via a network connection, an indication of a transaction conducted by the user using the proxy card. The instructions, when executed by the one or more processors, may further cause the proxy card server to retrieve, via a network connection, a proxy account linked to the proxy card from the proxy account repository. Further, the instructions, when executed by the one or more processors, may cause the proxy card server to record, by the one or more processors executing one or more processor-implemented instruction modules, a total amount of charges for the transaction in the proxy account. Still further, the instructions, when executed by the one or more processors, may cause the proxy card server to send, by the one or more processors executing one or more processor-implemented instruction modules, a notification to inform the user of the transaction. Additionally, the instructions, when executed by the one or more processors, may cause the proxy card server to apply, by the one or more processors executing one or more processor-implemented instruction modules, the corresponding payment method to clear the total amount of charges for the transaction in the proxy account. The computer system may include additional, fewer, or alternate instructions for execution on the one or more processors, including those discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

There are shown in the drawings arrangements which are presently discussed, it being understood, however, that the present embodiments are not limited to the precise arrangements and instrumentalities shown, wherein:

FIG. 1 is a block diagram of an exemplary system for processing payment card transactions by using a single proxy card;

FIG. 2 is a flow diagram of an exemplary method for processing payment card transactions by using a single proxy card;

FIG. 3 is a flow diagram of an exemplary process for processing payment card transactions by using a single proxy card;

FIG. 4 is a block diagram of various exemplary screenshots for processing payment card transactions by using a single proxy card; and

FIG. 5 is a block diagram of an exemplary computing environment that implements a system and method for processing payment card transactions by using a single proxy card.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The systems and methods disclosed herein generally relate to, inter alia, using a single proxy card to process payment card transactions. In particular, before commencing a transaction, a user may select a type of payment card and/or payment method to use for the single proxy card. During the transaction, charges incurred on the single proxy card may be recorded in a proxy account which is linked to the single proxy card. The payment method may then be applied to clear or reimburse the charges in the proxy account. In this manner, the user may use the single proxy card to switch between different types of payment cards to process various payment card transactions.

In one aspect, a single debit or credit card may be linked to a separate, user transparent bank account (or facsimile) from a user's already existing savings and checking accounts. This separate bank account may be monitored by an intermediate logic server (separate from the banking backend) which may perform the following actions: (1) send push/SMS notifications to the user when a new transaction is recorded to the account; (2) allow the user to choose an account (i.e., savings, checking, or credit line) or an account from an unaffiliated account (verified through a separate process) to reimburse any charges to the non-visible account (this may effectively reduce the number of bank cards the user must carry to one); and/or (3) allow the user to cancel the proxy card from a mobile device or the web in case of unauthorized activity.

Additionally or alternatively, providing an intermediate logic layer may allow any type of card to be used as the proxy card; it may require no special hardware and be quickly modular to upgrade to new card technologies, such as near field communication (NFC) or integrated circuit cards. Furthermore, with some embodiments, having a card which may “forward” charges makes deactivating the card less disastrous in case of loss as it may not be associated directly with any real accounts.

### I. Exemplary System for Processing Payment Card Transactions by Using a Single Proxy Card

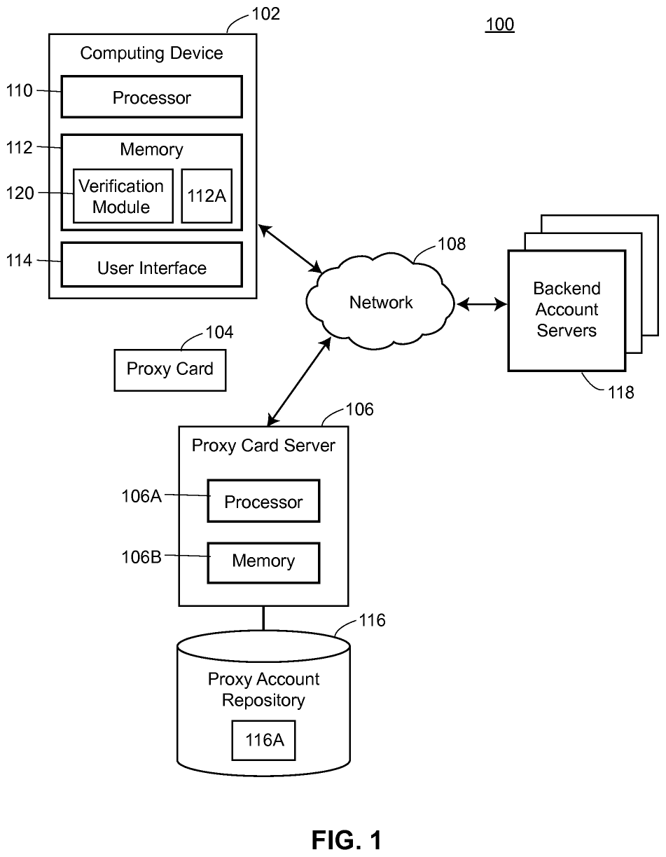

FIG. 1 depicts an exemplary system 100 for processing payment card transactions by using a single proxy card. The exemplary system 100 may include a computing device 102, a proxy card 104, and/or a proxy card server 106. The computing device 102 may be coupled to the proxy card server 106 via a communication network 108, which may include wired and/or wireless links. The computing device 102 may be, for example, a smart phone, a tablet computer, a laptop computer, or other computing or mobile devices capable of sending and receiving data over the network 108. Accordingly, the computing device 102 may include a processor 110, a memory 112, and a user interface 114 (e.g., a display screen, a touchscreen, a keyboard, etc.).

The proxy card server 106 may be a single server or a plurality of servers with distributed processing. The proxy card server 106 may include a processor 106A and a memory 106B, and may be directly coupled to a proxy account repository 116. In some embodiments, the repository 116 may not be directly coupled to the server 106, but instead may be accessible by the server 106 via a communication network such as the network 108.

The proxy card 104 may be based upon any type of card technology such as a magnetic stripe card, an integrated circuit card, a proximity card (e.g., using radio frequency identification (RFID), NFC, Bluetooth, etc.), a biometric card, etc. In some embodiments, instead of being a physical card, the proxy card 104 may be digitally stored in a device. For example, a digital representation of the proxy card 104 may be stored in the memory 112 of the computing device 102.

Typically, a user may possess various types of payment cards (e.g., a credit card, a debit card, a prepaid card, etc.) for processing transactions, such as making payments for a purchase. However, in order to overcome the inconvenience of carrying and using multiple different cards, the user may use the proxy card 104 to process any or all of the transactions. In other words, the proxy card 104 serves to consolidate the user's various payment cards into a single payment card.

To begin using the proxy card 104, a proxy account 116A may be established which is linked to the proxy card 104. In one embodiment, the proxy account 116A may be automatically created when the user first activates the proxy card 104. The proxy account 116A may be used to store charges that may be incurred by using the proxy card 104. The proxy account 116A may be saved in the proxy account repository 116, for example. Once the proxy account 116A is set up, the user may start selecting a type of payment card to be used as the proxy card 104. In doing so, a payment method for the proxy card 104 may also be selected, which is used to clear or reimburse any charges stored in the proxy account 116A.

Generally speaking, the payment method selected for the proxy card 104 may be associated with a funding source connected to the selected payment card. For example, if the user chooses a debit card as the proxy card 104, then the payment method for the proxy card 104 would correspond to a bank account (e.g., a checking account or a savings account) that is normally linked to the debit card. (Additionally or alternative, the present embodiments may include proxy cards associated with commercial or merchant accounts, such as online retailers, merchants, or insurance accounts associated with insurance providers that may provide financial, loan, and/or insurance products.) As another example, if the user chooses a credit card as the proxy card 104, then the payment method for the proxy card 104 would correspond to a credit line that is normally associated with the credit card. In any event, the payment method may be applied to clear or reimburse any charges accumulated in the proxy account 116A by transferring the appropriate funds or credits from the funding source connected to the selected payment card.

In operation, before a transaction is conducted, the user may use the computing device 102 to select a desired payment card to be used as the proxy card 104. More particularly, the user may choose the desired payment card (e.g., via the user interface 114) from a list of payment cards 112A stored in the memory 112 of the computing device 102. Each payment card in the list 112A has a corresponding payment method which is associated with the funding source (e.g., a bank account, a credit line, etc.) connected to each payment card. The funding source may be accessed through backend account servers 118 via the network 108. The backend account servers 118 may be part of a financial institution (e.g., a bank) where the funding source is located or stored. Accordingly, when the user selects the desired payment card, the corresponding payment method may also be selected. This in turn sets up access to the funding source associated with the desired payment card in the backend account servers 118.

Each payment card that the user owns may be included in the list 112A. At any time, the user may add new cards to the list 112A. Upon entering information about a new card, the processor 110 of the computing device 102 may execute a verification module 120 stored in the memory 112 of the computing device 102 to perform a verification process. The verification module 120 may communicate with the appropriate card issuing authority to request confirmation that the new card has indeed been properly issued and registered under the user's name. Once verified, the new card may be included in the list 112A. If desired, the user may also remove or delete existing cards from the list 112A that the user no longer owns or wishes to use. In some embodiments, the proxy card server 106 may perform the verification process. That is, the computing device 102 may transmit information about the new card to the server 106, and the server 106 may contact the appropriate card issuing authority to obtain verification on the status of the new card.

In one embodiment, a default payment card may be included in the list 112A and assigned to the proxy card 104. For example, the user's main debit card may be used as the default payment card. As such, the user's bank account linked to the main debit card may be used for the default payment method. The user may use the default payment card and default payment method for all ensuing transactions until or unless the user actively switches to a different payment card. Additionally or alternatively to linking the proxy or other card with a bank account, the proxy or other card may also be linked with various commercial accounts, such as accounts associated with online retailers, and/or insurance providers that may provide financial services and/or insurance products (e.g., automobile, home, health, life, pet, or health insurance).

After the user has selected the desired payment card along with the corresponding payment method, the computing device 102 may transmit that information to the proxy card server 106. Upon receiving the information, the processor 106A of the server 106 may execute instructions stored in the memory 106B of the server 106 to configure the proxy account 116A stored in the proxy account repository 116. In particular, the server 106 may configure the proxy account 116A to be cleared or reimbursed by the corresponding payment method associated with the selected desired payment card. In other words, the server 106 may set up a connection between the proxy account 116A and the funding source connected to the selected desired payment card. As a result, the server 106 may communicate with the backend account servers 118 via the network 108 to transfer the appropriate funds or credits from the funding source in order to clear or reimburse any charges that may appear in the proxy account 116A.

Once the server 106 finishes configuring the proxy account 116A, the user may begin to use the proxy card 104 to conduct one or more transactions. In one embodiment, the server 106 may send a notification alert to the computing device 102 to inform the user that the proxy card 104 is ready to be used. Whenever a transaction is conducted, all charges that result from the transaction are logged and recorded in the proxy account 116A. Further, whenever a transaction is conducted, the server 106 may send a message to the computing device 102 to notify the user of the occurrence of the transaction.

Thereafter, the charges in the proxy account 116A are cleared or reimbursed by applying the corresponding payment method associated with the selected desired payment card (i.e., by transferring funds or credits from the funding source). The server 106 may clear or reimburse the charges in the proxy account 116A on a periodic basis (e.g., during every server refresh cycle). Alternatively or additionally, charges incurred by using the selected desired payment card may be accumulated in the proxy account 116A, and the server 106 may clear or reimburse the charges whenever the user chooses to use another payment card for the proxy card 104. In one embodiment, after clearing the proxy account 116A, the server 106 may send a notification alert to the computing device 102 to inform the user that the proxy account 116A is now free of charges.

The proxy card server 106 may provide an intermediate logic layer that allows any type of payment card to be used as the proxy card 104. Further, the use of the proxy card 104 may require no specialized hardware and the proxy card 104 may be implemented using any type of card technology. Still further, deactivating or canceling the proxy card 104 in case of loss or unauthorized usage may be less of a hassle because the proxy card 104 only forwards charges to the proxy account 116A, which may be separate from any real account.

Moreover, as can be seen from the above the discussion, the system 100 may drastically improve the process by which payment card transactions are carried out, at least in part by providing a simple and efficient way to consolidate the user's various payment cards into a single payment card. In this manner, resource usage during the processing of payment card transactions may be greatly improved. For example, instead of having many different payment card servers that communicate with the backend account servers 118 to process transactions from different payment cards, the system 100 may only use the proxy card server 106 to communicate with the backend account servers 118. This may reduce the total number of payment card servers needed and thus the total number of processor cycles utilized by the servers. Further, the total number of messages or traffic sent over the network 108 to the backend account servers 118 during payment card transactions may also be greatly reduced, thereby increasing the efficiencies of the network 108.

In one aspect, the proxy card may be directly or indirectly to multiple accounts or types of accounts, such as bank, financial, debit card, or credit card accounts, and/or accounts associated with merchants, including insurance providers. For instance, in one embodiment, the proxy card may be electronically linked with a proxy account, and the proxy account may be electronically linked with multiple financial or commercial accounts. Additionally or alternatively, the proxy card may be electronically linked directly with the multiple financial or commercial accounts. When the proxy card is used to conduct a transaction, a payment other than the transaction may be processed, via the proxy account or otherwise, and the appropriate one of the multiple accounts may be charged/settled.

### II. Exemplary Method for Processing Payment Card Transactions by Using a Single Proxy Card

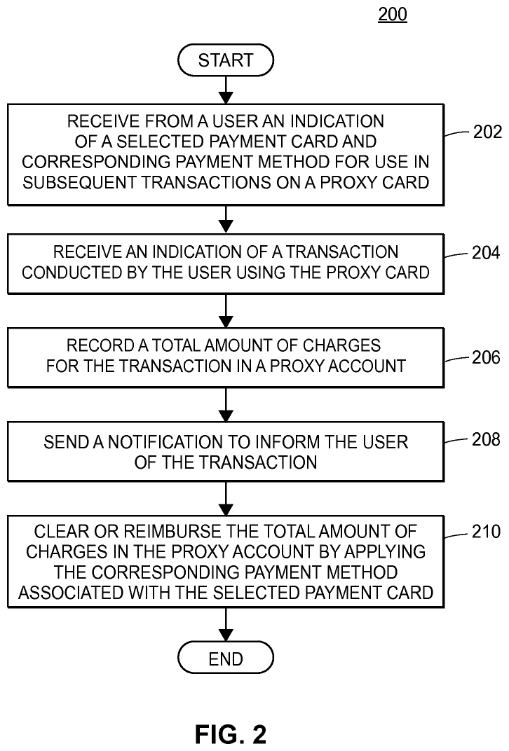

FIG. 2 depicts a flow diagram of an exemplary method 200 for processing payment card transactions by using a single proxy card. The method 200 may include one or more blocks, routines or functions in the form of computer executable instructions that are stored in a tangible computer-readable memory (e.g., 106B of FIG. 1) and executed using a processor (e.g., 106A of FIG. 1).

The method 200 may begin by receiving from a user an indication of a selected payment card and corresponding payment method for use in subsequent transactions on a proxy card (block 202). Generally, the user may possess various types of payment cards, each of which has a corresponding payment method that is associated with a funding source connected to each payment card. For better convenience, the user may consolidate the various types of payment cards by using the proxy card to process transactions. To do so, the user may select a payment card and the corresponding payment method to be used as the proxy card. As such, all subsequent transactions conducted on the proxy card may be based upon the selected payment card. In an embodiment, the method 200 may receive the indication of the selected payment card and the corresponding payment method from a computing device (e.g., the computing device 102 of FIG. 1) that the user is using. For example, the user may choose a particular payment card to use for the proxy card from a list of payment cards stored in the computing device.

Next, the method 200 may receive an indication of a transaction conducted by the user using the proxy card (block 204). Here, the user may proceed to conduct the transaction, such as making payments on the purchase of goods or services.

The method 200 may then proceed to record a total amount of charges incurred for the transaction in a proxy account (block 206). The proxy account may be linked to the proxy card. The purpose of the proxy account is to store any charges that may be incurred by using the proxy card during a transaction.

Whenever a transaction is conducted, the method 200 may also send a notification to inform the user of the transaction (block 208). For example, the method 200 may send a message to the computing device that the user is using (e.g., via the user interface 114 of FIG. 1). This may ensure that the user is properly made aware of the occurrence of the transaction.

Finally, the method 200 may clear or reimburse the total amount of charges in the proxy account by applying the corresponding payment method associated with the selected payment card (block 210). In particular, the method 200 may transfer the appropriate funds or credits from the funding source connected to the selected payment card to clear or reimburse the charges stored in the proxy account. The funding source may be accessed via a backend account server that is part of a financial institution where the funding source may be located or stored, for example.

### III. Exemplary Process for Processing Payment Card Transactions by Using a Single Proxy Card

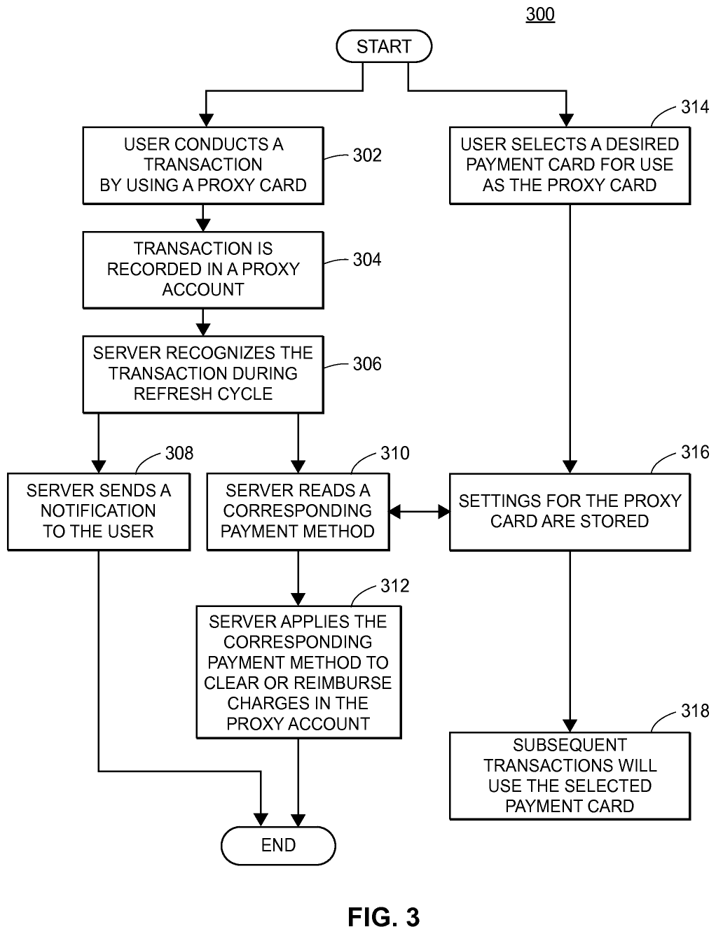

FIG. 3 depicts a flow diagram of an exemplary process 300 for processing payment card transactions by using a single proxy card.

The process 300 begins when a user conducts a transaction by using a proxy card (block 302). The transaction is then recorded in a proxy account linked to the proxy card (block 304). The proxy account is used to store charges that are incurred by using the proxy card during the transaction.

Next, a server managing or handling the proxy account recognizes the transaction during a refresh cycle (block 306). The server may be the proxy card server 106 of FIG. 1, for example. Once the server sees the transaction, the server sends a notification to inform the user that the transaction has just taken place (block 308). At the same time, the server reads or identifies a corresponding payment method associated with the proxy card (block 310). Thereafter, the server applies the corresponding payment method to clear or reimburse any charges stored in the proxy account (block 312).

Before a particular transaction is conducted, the process 300 may allow the user to select a desired payment card for use as the proxy card (block 314). In general, the user may own or possess various types of payment cards, each of which has a payment method. As such, when the user selects the desired payment card for use as the proxy card, the payment method for the payment card is also selected as the corresponding payment method associated with the proxy card. The selected payment card and payment method are stored and represent settings for the proxy card (block 316). Accordingly, in block 310, the server may access the settings to obtain the corresponding payment method associated with the proxy card. Once the settings for the proxy card are established, all subsequent transactions will be carried out using the selected payment card (block 318). For example, the process 300 may proceed from block 318 to block 302.

### IV. Exemplary Screenshots for Processing Payment Card Transactions by Using a Single Proxy Card

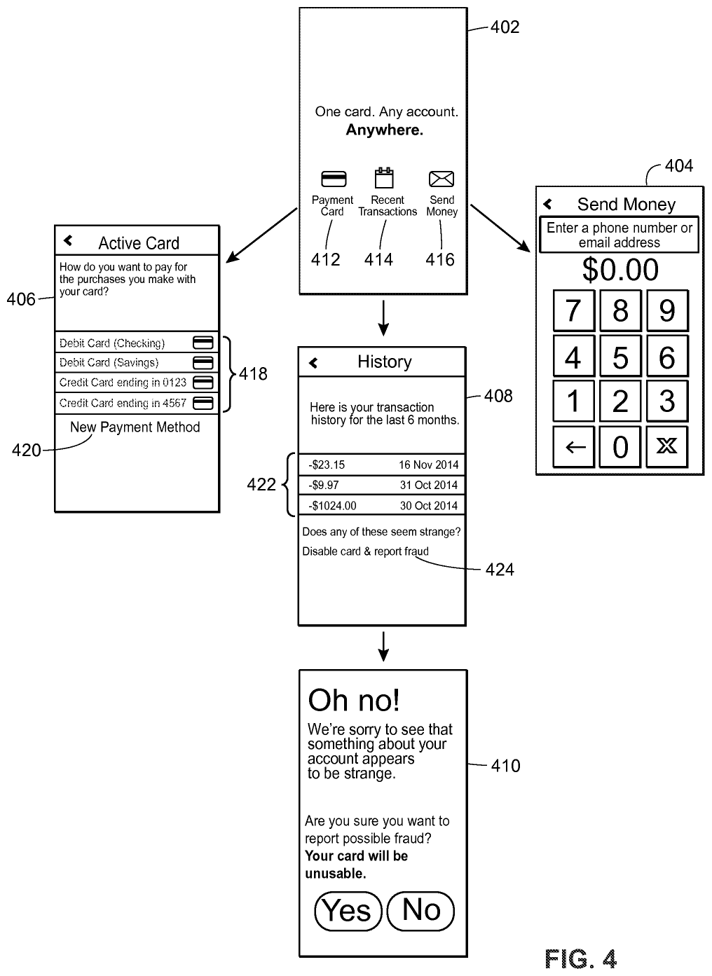

FIG. 4 depicts various exemplary screenshots 402-410 for processing payment card transactions by using a single proxy card. The various screenshots 402-410 may be generated on a computing device (e.g., the computing device 102 of FIG. 1) and displayed to a user (e.g., via the user interface 114 of FIG. 1). The screenshots 402-410 may be associated with a user interface that allows a user to manage the proxy card, and various payment cards and/or corresponding payment methods.

In particular, FIG. 4 shows a launch screenshot 402 which is generated when the user first initiates the procedure to use a proxy card for processing payment card transactions. From the launch screenshot 402, the user may select one of three options: select a payment card 412, view recent transactions 414, and/or send money 416.

When the user selects the payment card option 412, an active card screenshot 406 is generated, which may show a list of available payment cards 418. As such, the user may choose a desired payment card and the corresponding payment method from the list of available payment cards 418 for use in subsequent transactions on the proxy card. The user may also add a new payment card and/or corresponding payment method to the list 418 by selecting an add payment card button 420.

When the user selects the send money option 416, a send money screenshot 404 is generated. Here, the user may send or transfer money via the active payment card and/or corresponding payment method, as selected from the screenshot 406, to another user based upon a phone number or an email address, for example.

When the user selects the recent transactions option 414, a history screenshot 408 is generated, which may show a list of recent transactions 422 made on, or using, the proxy card. All transactions made with the proxy card may be available for viewing. In one embodiment, the screenshot 408 may only show transactions made during a specific period of time (e.g., in the last six months). Further, whenever a transaction is conducted on the proxy card, the user may receive an indication of that transaction.

In the history screenshot 408, if the user suspects or detects that fraudulent transactions have taken place and/or if the user has lost the proxy card, the user may have the ability to immediately cancel (or freeze) the proxy card. The user may do this by selecting a disable card button 424. When the disable card button 424 is selected, a disable confirmation screenshot 410 may be generated. Here, the user may confirm that he or she wishes to cancel (or freeze) the proxy card. Once the proxy card is cancelled (or frozen), a notification may be sent to a banking representative so that the banking representative may contact the user in order to help the user resolve any issues with the proxy card.

Additionally or alternatively, in the history screenshot 408, if the user suspects or detects that fraudulent transactions have taken place with specific accounts, the user may have the ability to immediately cancel (or freeze) the respective individual accounts or payment cards, such as those depicted in the list 418. The user may do this by selecting an icon, such as the disable card button 424. When the disable card button 424 is selected, a disable confirmation screenshot 410 may be generated. Here, the user may confirm that he or she wishes to cancel (or freeze) the individual payment card and/or corresponding payment method from the list 418. Once the individual payment card and/or corresponding payment method proxy card is cancelled (or frozen), a notification may be sent to a banking representative so that the banking representative may contact the user in order to help the user resolve any issues with the individual payment card and/or corresponding payment method. Other user interfaces having additional, less, or alternate functionality may be used, including that discussed elsewhere herein.

### V. Exemplary Method

In one aspect, a computer-implemented method for processing payment card transactions may be provided. The method may include (1) receiving, by one or more processors executing a processor-implemented instruction module, an indication of a selected payment card and/or a corresponding payment method from a user for use in subsequent transactions on a proxy card; (2) receiving, by the processor-implemented instruction module, an indication of a transaction conducted by the user using the proxy card; (3) recording, by the processor-implemented instruction module, a total amount of charges for the transaction in a proxy account linked to the proxy card; (4) sending, by the processor-implemented instruction module, a notification to inform the user of the transaction; and/or (5) applying, by the processor-implemented instruction module, the corresponding payment method to clear the total amount of charges for the transaction in the proxy account. The method may include additional, fewer, or alternate actions, including those discussed elsewhere herein.

The corresponding payment method may be associated with a funding source connected to the selected payment card. Applying the corresponding payment to clear the total amount of charges may further include transferring an appropriate amount of funds or credits from the funding source connected to the selected payment method to the proxy account to reimburse the total amount of charges stored in the proxy account. The corresponding payment method may be applied to clear the total amount of charges in the proxy account on a periodic basis. Alternatively or additionally, the corresponding payment method may be applied to clear the total amount of charges in the proxy account when the user chooses another payment card as the selected payment card.

The selected payment card and the corresponding payment method may be selected by the user from a list of payment cards that identifies various types of payment cards that the user owns or uses. Additionally, a new payment card and corresponding payment method may be added to the list of payment cards through a verification process.

The proxy card may be based upon one or more of a magnetic stripe card, an integrated circuit card, a radio frequency identification proximity card, a near field communication proximity card, and/or a biometric card. The proxy card may also be a digital representation of a physical card stored in a memory of a computing device.

### VI. Exemplary Computer System

In one aspect, a computer system for processing payment card transactions may be provided. The computer system may include a proxy account repository and a proxy card server, including a memory having instructions for execution on one or more processors. The instructions, when executed by the one or more processors, may cause the proxy card server to receive, via a network connection, an indication of a selected payment card and a corresponding payment method from a user for use in subsequent transactions on a proxy card; receive, via a network connection, an indication of a transaction conducted by the user using the proxy card; retrieve, via a network connection, a proxy account linked to the proxy card from the proxy account repository; record, by the one or more processors executing one or more processor-implemented instruction modules, a total amount of charges for the transaction in the proxy account; send, by the one or more processors executing one or more processor-implemented instruction modules, a notification to inform the user of the transaction; and/or apply, by the one or more processors executing one or more processor-implemented instruction modules, the corresponding payment method to clear the total amount of charges for the transaction in the proxy account. The computer system may include additional, less, or alternate components, including those discussed elsewhere herein.

The corresponding payment method may be associated with a funding source connected to the selected payment card. The instructions of the proxy card server, when executed by the one or more processors to apply the corresponding payment to clear the total amount of charges may further include instructions to transfer an appropriate amount of funds or credits from the funding source connected to the selected payment method to the proxy account to reimburse the total amount of charges stored in the proxy account.

### VII. Exemplary Non-Transitory Storage Medium

In one aspect, a non-transitory computer-readable storage medium including computer-readable instructions may be executed on one or more processors of a system for processing payment card transactions. The instructions, when executed, may cause the one or more processors to receive, by a processor-implemented instruction module, an indication of a selected payment card and a corresponding payment method from a user for use in subsequent transactions on a proxy card; receive, by the processor-implemented instruction module, an indication of a transaction conducted by the user using the proxy card; record, by the processor-implemented instruction module, a total amount of charges for the transaction in a proxy account linked to the proxy card; send, by the processor-implemented instruction module, a notification to inform the user of the transaction; and/or apply, by the processor-implemented instruction module, the corresponding payment method to clear the total amount of charges for the transaction in the proxy account.

The corresponding payment method may be associated with a funding source connected to the selected payment card. The instructions, when executed on the one or more processors to apply the corresponding payment to clear the total amount of charges may further include instructions to transfer an appropriate amount of funds or credits from the funding source connected to the selected payment method to the proxy account to reimburse the total amount of charges stored in the proxy account. The instructions may direct or control additional, less, or alternate functionality, including that discussed elsewhere herein.

The selected payment card and the corresponding payment method may be selected by the user from a list of payment cards that identifies various types of payment cards that the user owns or uses. Additionally, a new payment card and corresponding payment method can be added to the list of payment cards through a verification process.

The proxy card may be based on one or more of a magnetic stripe card, an integrated circuit card, a radio frequency identification proximity card, a near field communication proximity card, or a biometric card.

### VIII. Exemplary Computing Environment

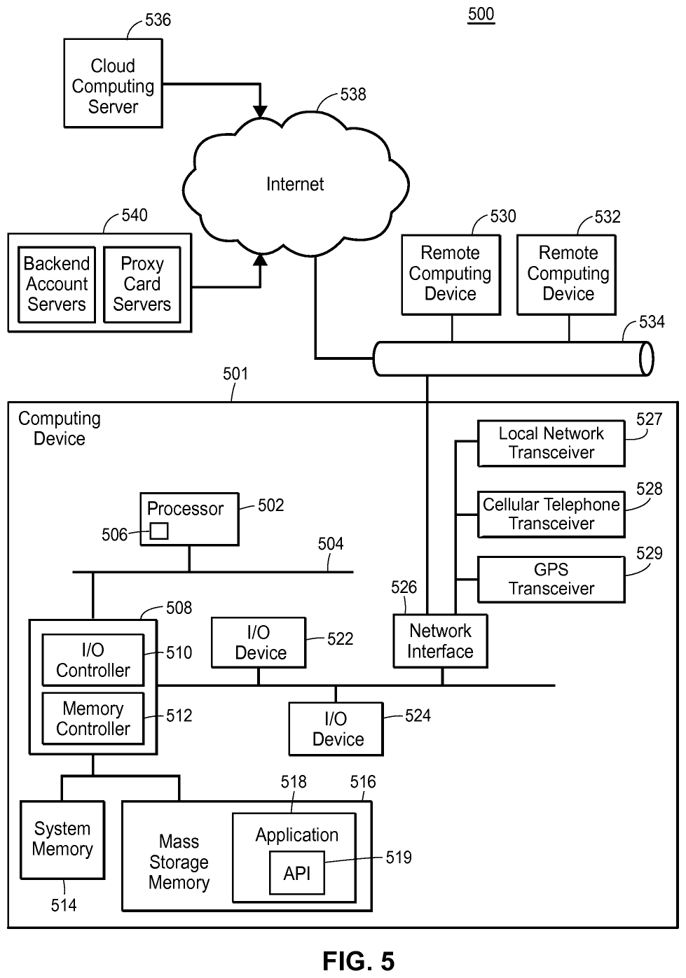

FIG. 5 is a block diagram of an exemplary computing environment for a system 500 having a computing device 501 that may be used to implement the systems and methods described herein. The computing device 501 may be a computing device (e.g., a smart phone, a tablet computer, a laptop computer, a Wi-Fi-enabled device, etc.), a server, or other types of computing or mobile devices. Processor systems similar or identical to the system 500 may be used to implement and execute the exemplary system of FIG. 1, the exemplary method of FIG. 2, the exemplary process of FIG. 3, and the like. Although the system 500 is described below as including a plurality of peripherals, interfaces, chips, memories, etc., one or more of those elements may be omitted from other exemplary processor systems used to implement and execute the exemplary system 100. Also, other components may be added.

As shown in FIG. 5, the computing device 501 may include a processor 502 that is coupled to an interconnection bus 504. The processor 502 may include a register set or register space 506, which is depicted in FIG. 5 as being entirely on-chip, but which could alternatively be located entirely or partially off-chip and directly coupled to the processor 502 via dedicated electrical connections and/or via the interconnection bus 504. The processor 502 may be any suitable processor, processing unit or microprocessor. Although not shown in FIG. 5, the computing device 501 may be a multi-processor device and, thus, may include one or more additional processors that are identical or similar to the processor 502 and that are communicatively coupled to the interconnection bus 504.

The processor 502 of FIG. 5 may be coupled to a chipset 508, which may include a memory controller 510 and a peripheral input/output (I/O) controller 512. As is well known, a chipset typically provides I/O and memory management functions, as well as a plurality of general purpose and/or special purpose registers, timers, etc. that are accessible or used by one or more processors coupled to the chipset 508. The memory controller 510 performs functions that enable the processor 502 (or processors if there are multiple processors) to access a system memory 514 and a mass storage memory 516, that may include either or both of an in-memory cache (e.g., a cache within the memory 514) or an on-disk cache (e.g., a cache within the mass storage memory 516).

The system memory 514 may include any desired type of volatile and/or non-volatile memory such as, for example, static random access memory (SRAM), dynamic random access memory (DRAM), flash memory, read-only memory (ROM), etc. The mass storage memory 516 may include any desired type of mass storage device. For example, if the computing device 501 is used to implement an application 518 having an API 519 (including functions and instructions as described by the method 200 of FIG. 2), the mass storage memory 516 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 501 and the system 500. Thus, a module, block, function, operation, procedure, routine, step, and method may be implemented in hardware, firmware, and/or software. In one embodiment, program modules and routines (e.g., the application 518, the API 519, etc.) are stored in mass storage memory 516, loaded into system memory 514, and executed by a processor 502 or may be provided from computer program products that are stored in tangible computer-readable storage mediums (e.g., RAM, hard disk, optical/magnetic media, etc.).

The peripheral I/O controller 510 may perform functions that enable the processor 502 to communicate with peripheral input/output (I/O) devices 522 and 524, a network interface 526, a local network transceiver 527, a cellular network transceiver 528, and a GPS transceiver 529 via the network interface 526. The I/O devices 522 and 524 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The cellular telephone transceiver 528 may be resident with the local network transceiver 527. The local network transceiver 527 may include support for a Wi-Fi network, Bluetooth, Infrared, or other wireless data transmission protocols.

In other embodiments, one element may simultaneously support each of the various wireless protocols employed by the computing device 501. For example, a software-defined radio may be able to support multiple protocols via downloadable instructions. In operation, the computing device 501 may be able to periodically poll for visible wireless network transmitters (both cellular and local network) on a periodic basis. Such polling may be possible even while normal wireless traffic is being supported on the computing device 501. The network interface 526 may be, for example, an Ethernet device, an asynchronous transfer mode (ATM) device, an 802.11 wireless interface device, a DSL modem, a cable modem, a cellular modem, etc., that enables the system 500 to communicate with another computer system having at least the elements described in relation to the system 100.

While the memory controller 512 and the I/O controller 510 are depicted in FIG. 5 as separate functional blocks within the chipset 508, the functions performed by these blocks may be integrated within a single integrated circuit or may be implemented using two or more separate integrated circuits. The system 500 may also implement the application 518 on remote computing devices 530 and 532. The remote computing devices 530 and 532 may communicate with the computing device 501 over an Ethernet link 534. In some embodiments, the application 518 may be retrieved by the computing device 501 from a cloud computing server 536 via the Internet 538. When using the cloud computing server 536, the retrieved application 518 may be programmatically linked with the computing device 501. The application 518 may be a Java® applet executing within a Java® Virtual Machine (JVM) environment resident in the computing device 501 or the remote computing devices 530, 532. The application 518 may also be “plug-ins” adapted to execute in a web-browser located on the computing devices 501, 530, and 532. In some embodiments, the application 518 may communicate with backend components 540 such as the proxy card server 106, and the backend account servers 118 via the Internet 538.

The system 500 may include, but is not limited to, any combination of a LAN, a MAN, a WAN, a mobile, a wired or wireless network, a private network, or a virtual private network. Moreover, while only two remote computing devices 530 and 532 are illustrated in FIG. 5 to simplify and clarify the description, it is understood that any number of client computers are supported and may be in communication within the system 500.

Additionally, certain embodiments are described herein as including logic or a number of components, modules, or mechanisms. Modules may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

The performance of certain of the operations may be distributed among the one or more processors, not only residing within a single machine, but deployed across a number of machines. In some exemplary embodiments, the one or more processors or processor-implemented modules may be located in a single geographic location (e.g., within a home environment, an office environment, or a server farm). In other exemplary embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” means that a particular element, feature, structure, or characteristic described in connection with the embodiment is included in at least one embodiment. The appearances of the phrase “in some embodiments” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the Figures depict preferred embodiments of a system and method for processing payment card transactions by using a single proxy card for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for a system and a process for processing payment card transactions by using a single proxy card through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method for processing payment card transactions, the method comprising:
receiving, by one or more processors executing a processor-implemented instruction module, an indication of a selected payment card and a corresponding payment method from a user for use in subsequent purchases transacted on a proxy card;
receiving, by the processor-implemented instruction module, an indication of each purchase transaction conducted by the user using the proxy card;
recording, by the processor-implemented instruction module, an accumulation of purchase transactions incurred with the proxy card into a proxy account linked to the proxy card, the accumulation of purchase transactions including pending charges;
sending, by the processor-implemented instruction module, a notification to inform the user of each purchase transaction conducted by the user using the proxy card; and
applying, by the processor-implemented instruction module and on a periodic basis, the corresponding payment method to clear at least a portion of the accumulation of pending charges in the proxy account.

2. The computer-implemented method of claim 1, wherein the corresponding payment method is associated with a funding source connected to the selected payment card.

3. The computer-implemented method of claim 2, wherein applying the corresponding payment method to clear the at least a portion of the accumulation of pending charges includes transferring an appropriate amount of funds or credits from the funding source connected to the selected payment method to the proxy account to reimburse the at least a portion of the accumulation of pending charges stored in the proxy account.

4. (canceled)

5. The computer-implemented method of claim 1, wherein the corresponding payment method is applied to clear the at least a portion of the accumulation of pending charges in the proxy account whenever the user chooses.

6. The computer-implemented method of claim 1, wherein the selected payment card and the corresponding payment method are selected by the user from a list of payment cards that identifies various types of payment cards that the user owns or uses.

7. The computer-implemented method of claim 6, wherein a new payment card and corresponding payment method can be added to the list of payment cards through a verification process.

8. The computer-implemented method of claim 1, wherein the proxy card is based on one or more of a magnetic stripe card, an integrated circuit card, a radio frequency identification proximity card, a near field communication proximity card, or a biometric card.

9. The computer-implemented method of claim 1, wherein the proxy card is a digital representation of a physical card stored in a memory of a computing device.

10. A non-transitory computer-readable storage medium including computer-readable instructions to be executed on one or more processors of a system for processing payment card transactions, the instructions when executed causing the one or more processors to:
receive an indication of a selected payment card and a corresponding payment method from a user for use in subsequent purchases transacted on a proxy card;
receive an indication of each purchase transaction conducted by the user using the proxy card;
record an accumulation of purchase transactions incurred with the proxy card into a proxy account linked to the proxy card, the accumulation of purchase transactions including pending charges;
send a notification to inform the user of each purchase transaction conducted using the proxy card; and
apply, on a periodic basis, the corresponding payment method to clear at least a portion of the accumulation of pending charges in the proxy account.

11. The non-transitory computer-readable storage medium of claim 10, wherein the corresponding payment method is associated with a funding source connected to the selected payment card.

12. The non-transitory computer-readable storage medium of claim 11, wherein the instructions to apply the corresponding payment method to clear the at least a portion of the accumulation of pending charges include transferring an appropriate amount of funds or credits from the funding source connected to the selected payment method to the proxy account to reimburse the at least a portion of the accumulation of pending charges stored in the proxy account.

13. The non-transitory computer-readable storage medium of claim 10, wherein the selected payment card and the corresponding payment method are selected by the user from a list of payment cards that identifies various types of payment cards that the user owns or uses.

14. The non-transitory computer-readable storage medium of claim 13, wherein a new payment card and corresponding payment method can be added to the list of payment cards through a verification process.

15. The non-transitory computer-readable storage medium of claim 10, wherein the proxy card is based on one or more of a magnetic stripe card, an integrated circuit card, a radio frequency identification proximity card, a near field communication proximity card, or a biometric card.

16. A computer system for processing payment card transactions, the system comprising:
a proxy account repository; and
a proxy card server, including a memory having instructions for execution on one or more processors, wherein the instructions, when executed by the one or more processors, cause the proxy card server to:
receive, via a network connection, an indication of a selected payment card and a corresponding payment method from a user for use in subsequent purchases transacted on a proxy card;
receive, via a network connection, an indication of each purchase transaction conducted by the user using the proxy card;
retrieve, via a network connection, a proxy account linked to the proxy card from the proxy account repository;
record an accumulation of purchase transactions incurred with the proxy card into a proxy account linked to the proxy card, the accumulation of purchase transactions including pending charges;
record, by the one or more processors executing one or more processor-implemented instruction modules, an accumulation of purchase transactions incurred with the proxy card into the proxy account linked to the proxy card, the accumulation of purchase transactions including pending charges;
send, by the one or more processors executing one or more processor-implemented instruction modules, a notification to inform the user of each purchase transaction conducted using the proxy card; and
apply, by the one or more processors executing one or more processor-implemented instruction modules and on a periodic basis, the corresponding payment method to clear at least a portion of the accumulation of pending charges in the proxy account.

17. The computer system of claim 16, wherein the corresponding payment method is associated with a funding source connected to the selected payment card.

18. The computer system of claim 17, wherein the instructions of the proxy card server, when executed by the one or more processors to apply the corresponding payment to clear the at least a portion of the accumulation of pending charges further include instructions to transfer an appropriate amount of funds or credits from the funding source connected to the selected payment method to the proxy account to reimburse the at least a portion of the accumulation of pending charges stored in the proxy account.
